(19) United States
(12) Patent Application Publication
(10) Pub. No.: US 2006/0281192 A1
(43) Pub. Date: Dec. 14, 2006

(54) Method for mixing fluids in microfluidic systems

(76) Inventors: Philip H. Harding, Albany, OR (US); Christopher Beatty, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/152,260

(22) Filed: Jun. 13, 2005

(51) Int. Cl. G01N 1/10

(52) U.S. Cl. 436/180

(57) ABSTRACT

A method for mixing liquids on a microfluidic level comprises the steps of rotating a coupon to impart flow via centripetal force to a first liquid through a microchannel in the coupon to inject the first liquid into a mixing chamber to mix the first liquid with a second liquid, withdrawing a quantity of the first and second liquids from the mixing chamber, and injecting at least a portion of the quantity of the first and second liquids into the mixing chamber to further mix the first and second liquids.

### FIELD OF THE INVENTION

The present invention relates generally to systems for mixing microfluids.

### BACKGROUND OF THE INVENTION

The use of microfluidic systems for the acquisition of chemical and biological information is becoming increasingly popular due to a number of considerations. For example, complicated biochemical reactions, when conducted in microfluidic volumes, may be carried out using very small volumes of liquid. As the volume of a particular liquid needed for such testing regimes is small, often on the order of nanoliters, the amounts of reagents and analytes used can be greatly reduced. Reduction in the amounts of reagents and analytes can greatly reduce the costs associated with microfluidic testing compared to conventional testing systems.

In addition, the response time of reactions is often much faster in microfluidic systems, leading to a decrease in the overall time required for a particular test regime. Also, when volatile or hazardous materials are used or generated during testing, performing reactions in microfluidic volumes can increase the safety of a testing regime and can also reduce the quantities of hazardous materials that require specialized disposal after testing is completed.

While microfluidic testing is increasing in popularity, the technology associated with microfluidic testing remains problematic in a number of areas. In particular, mixing of fluids at the microfluid level remains difficult. Fluids passing through small channels (on the order of one mm and smaller) have relatively little inertia, and viscous forces thus generally dominate the flow patterns of such liquids. The result of such flow patterns is that fluids tend to remain streamlined, thus making combining and/or mixing of two dissimilar fluids at the microfluidic level challenging.

Accordingly, while it is desired to use microfluidic test systems in a wide range of applications, the limitations inherent in mixing fluids at the microfluidic level remain problematic.

### SUMMARY OF THE INVENTION

It has been recognized that it would be advantageous to develop a system for effectively mixing liquids at the microfluidic level. The present invention provides a method for mixing liquids on a microfluidic level, including the step of placing a coupon in operable communication with a rotational device, the coupon including: at least one fluid reservoir containing a first liquid; a fluid mixing chamber; and a microchannel interconnecting the fluid reservoir and the fluid mixing chamber. The method can include the steps of determining a target contact velocity for the first liquid to enter the mixing chamber and determining a target rotational velocity of the coupon at which the first liquid will be released from the fluid reservoir such that the first liquid is traveling at least at the target contact velocity as it enters the mixing chamber. The method can also include the steps of rotating the coupon at or above the target rotational velocity, and releasing the first liquid from the fluid reservoir such that the first liquid travels through the microchannel and is injected into the mixing chamber at least at the target contact velocity, thereby mixing in the mixing chamber the first liquid with a second liquid present in the mixing chamber.

In accordance with another aspect of the present invention, a method for mixing liquids on a microfluidic level is provided, including the steps of rotating a coupon to impart flow via centripetal force to a first liquid through a microchannel in the coupon to inject the first liquid into a mixing chamber to mix the first liquid with a second liquid, withdrawing a quantity of the first and second liquids from the mixing chamber, and injecting at least a portion of the quantity of the first and second liquids into the mixing chamber to further mix the first and second liquids.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic, top view of a microfluidic test coupon in accordance with an embodiment of the present invention;

FIG. 2 is a schematic, top view of another microfluidic test coupon in accordance with an embodiment of the present invention;

FIG. 3A is a schematic, top view of a section of the microfluidic test coupon of FIG. 2 in accordance with an embodiment of the present invention, shown prior to rotation of the test coupon;

FIG. 3B is a schematic, top view of the section of the microfluidic test coupon of FIG. 3A, shown after rotation of the test coupon;

FIG. 3C is a schematic, top view of the section of the microfluidic test coupon of FIG. 3A, shown after mixed fluid has been withdrawn from the mixing chamber of the coupon;

FIG. 3D is a schematic, top view of the section of the microfluidic test coupon of FIG. 3A, shown after further rotation of the test coupon; and

FIG. 4 is a schematic, top view of a section of a microfluidic test coupon in accordance with another embodiment of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used:

The singular forms “a,” “an,” and “the” include plural referents unless the context clearly dictates otherwise.

As used herein, the terms “test coupon” or “coupon” are to be understood to refer to a device used to test one or more microfluids in a centrifugation test regime. Test coupons utilized in the present invention can include, but are not limited to, disk-shaped devices formed of poly(methyl methacrylate) (“PMMA”), polystyrene (“PS”), acetonitrile-butadiene-styrene (“ABS”), polycarbonate, etc. While not so limited, such disks can be similar in appearance to well-known compact disks (“CDs”).

As used herein, the term “passive valve” is to be understood to refer to a static valve with no moving parts that acts as a fluid valve due primarily to its geometric configuration.

As used herein, the term “capillary valve” is to be understood to refer to a passive valve presenting a junction between two or more capillary channels and/or reservoirs having at least one dimension less than about 1 mm.

As used herein, the term “microfluidics” and “microfluid” are to be understood to refer to fluids manipulated in systems that confine the fluids within geometric channels, passages or reservoirs having at least one dimension less than about 1 mm. Similarly, the terms “microfluidic channel,” or “microchannel” are to be understood to refer to channels having at least one dimension less than about 1 mm.

As used herein, the term “mixing” is to be understood to refer to a process by which two or more liquids are at least partially combined. The term “mixing” is not limited to any particular level of homogeneity achieved between two or more liquids. Thus, two or more liquids can be “mixed” when only a small portion of one liquid is interspersed in another liquid.

It is to be understood that the various features shown in the attached figures are for the purposes of illustration and do not in any manner limit the present invention. In particular, various fluids are represented in the figures by hatch marks. The hatch marks used to indicate the presence of a fluid are not to be construed to limit the invention to any particular type of fluid or material, even in the case where the hatch markings used may correspond to hatch markings used by those in various fields of endeavor to indicate a specific fluid or material.

In addition, the relative levels of fluids in various reservoirs are shown schematically herein to aid in understanding of the invention, and may not provide an accurate indication of an actual amount of fluid contained within a reservoir or channel. Also, it is to be understood that fluids contained within channels, reservoirs or chambers can be forced toward one side or another of the channel, reservoir or chamber, depending upon the net forces acting on the fluid body due to gravity, centripetal force, etc. Therefore, the fact that a body of fluid is shown in the figures as having an “upper” surface oriented in any particular direction may not correspond to the actual orientation of a fluid in a channel, reservoir or chamber.

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides systems for effectively mixing liquids on a microfluidic level that can be adapted for use with a variety of testing regimes. Examples of testing regimes that can benefit from the present invention include microfluidic biological, enzymatic, immunological and chemical assay regimes. It is desirable to perform such testing on a microfluidic level for several reasons. Among other reasons, such systems generally utilize volumes of testing fluids well below those used in conventional systems, leading to advantages in decreased costs, more rapid reaction times and minimized production and/or use of biohazardous materials.

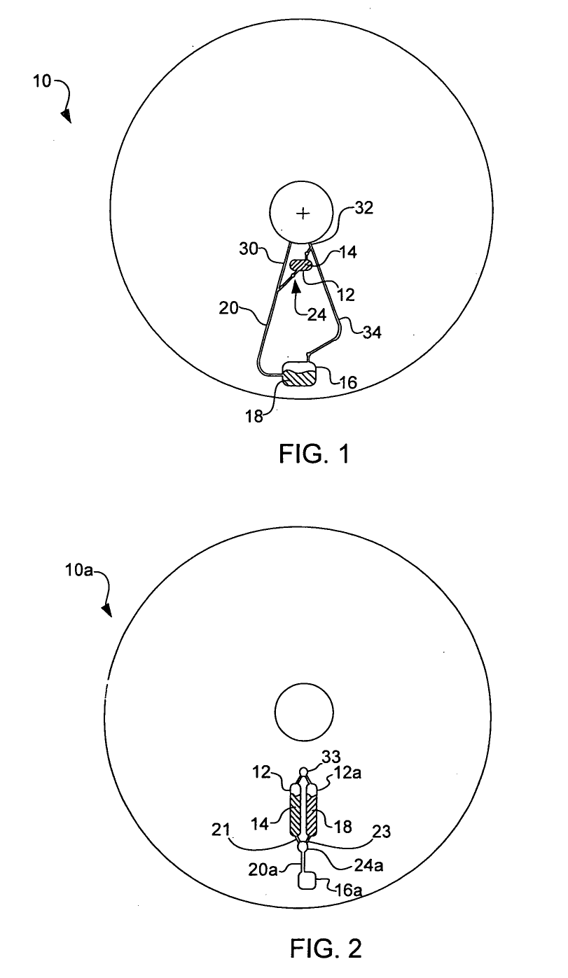

An exemplary configuration of a test coupon in accordance with the present invention is shown generally at 10 in FIG. 1. The test coupon can include at least one fluid reservoir 12 that can contain a first liquid 14, and a fluid mixing chamber 16. In the embodiment shown, the fluid mixing chamber contains a second liquid 18 with which it is desired that the first liquid be mixed. A microchannel 20 can interconnect the fluid reservoir and the fluid mixing chamber to provide fluid flow from the reservoir to the mixing chamber.

A valve 24 can be operably disposed between the fluid reservoir and the fluid mixing chamber to control the flow of fluid between the reservoir and the mixing chamber. The valve is generally operable to release flow of the first liquid from the reservoir while the coupon is being rotated at a particular rotational velocity. The type of valve incorporated into the coupon can vary and can include manually operated valves, automated valves and passive valves.

In those embodiments in which the valve comprises a passive valve, the passive valve can include a capillary valve configured to allow flow of the first liquid 14 from the fluid reservoir 12 when the coupon rotates at or above a particular, target rotational velocity. Such passive valves have been found advantageous due to their relative simplistic operation and generally require no moving parts or control circuitry to open or close the valves.

The passive, capillary valves of the present invention are based on the use of rotationally-induced fluid pressure which, when exceeding a particular pressure, are sufficient to overcome capillary forces which tend to prevent liquids from flowing. Liquids which completely or partially wet internal surfaces of microchannels which contain them experience a resistance to flow when moving from a microchannel of narrow cross section to one of larger cross section. Conversely, liquids that do not wet these surfaces resist flowing from microchannels of large cross section to those with smaller cross section. The capillary pressure can vary according to the sizes of the two microchannels in question, the surface tension of the fluid, and the contact angle of the fluid on the material of the microchannels.

The size of microchannels utilized in the present invention is generally less than about 1 mm, and often as small as about 500 μm or less. By varying capillary valve cross sectional dimensions as well as the position and extent along the radial direction of the fluid flow components of the present test coupons, capillary valves are developed which release fluid flow in a rotation-dependent manner. Capillary valves similar to those utilized herein are discussed in detail in publications such as U.S. Pat. No. 6,143,248.

The various microchannels and reservoirs utilized in the present test coupons can be formed in the coupon in a variety of manners. In one embodiment, these features can be machined in an upper surface of a disk using conventional milling techniques. After milling, a covering, such as a thin polymer film, can be applied over each channel and reservoir to enclose each channel or reservoir. In addition to this method, it is contemplated that the geometric features of the test coupons can be formed in a variety of manners known to those having ordinary skill in the art.

A method in accordance with the present invention for mixing two or more liquids at the microfluidic level can include the step of placing the coupon 10 in operable communication with a rotational device (not shown). A target contact velocity for the first liquid 14 to enter the mixing chamber 18 can be determined, based on a number of considerations that will be described hereinafter. Once the target contact velocity is determined, the method can include the step of determining a target rotational velocity of the coupon at which the first liquid will be released from the fluid reservoir 12 such that the first liquid is traveling at least at the target contact velocity as it enters the mixing chamber.

The coupon 10 can then be rotated at the target rotational velocity and the first liquid 14 can be released from the fluid reservoir 12 such that the first liquid travels through the microchannel 20 toward the mixing chamber 16. Upon reaching the mixing chamber, the first fluid is injected into the mixing chamber (while traveling at least at the target contact velocity), and is thereby mixed with the second liquid 18 contained in the mixing chamber.

In the case where valve 24 is a capillary valve, the valve can be configured to resist flow of the first liquid from the reservoir until the coupon is rotated at a rate fast enough to generate centripal forces acting on the first liquid which are sufficient to overcome the capillary forces which hold the liquid at the valve 24. Once the coupon is rotated at such a sufficiently fast rate, the first liquid will be released through the valve and will accelerate through the microchannel until reaching the mixing chamber at a particular volumetric flow rate, or velocity. Upon entering the mixing chamber at this particular velocity, the target contact velocity, the first liquid mixes with the second liquid 18.

The target contact velocity of a fluid can be determined based on a number of factors, including various material properties of the fluid, and various considerations relevant to the interaction between the fluid and another fluid with which it is desired to be mixed. For example, it is well known that properties of a fluid such as viscosity, surface tension, density, etc., can all affect the tendency of the fluid to mix with another fluid. Similarly, material properties of the fluid with which the first fluid is to be mixed can affect the tendency of the first fluid to mix with the second. Thus, the step of determining a target contact velocity of the first fluid will generally vary with the particular testing regime with which the fluids are used, as well as the material properties of each fluid. For most known test fluids and testing regimes, however, the step of determining the target contact velocity of the first fluid can be performed using known calculations. Examples of concepts used to derive such equations can be found, for example, in U.S. Pat. No. 6,709,869.

Determining a target rotational velocity of the coupon 10 at which the first liquid 14 will be released from the reservoir 12 can be done once a target contact velocity has been determined. In general, immediately upon being released from the fluid reservoir, the first fluid will have a volumetric flow rate, or velocity, of zero. Due to the centripetal force applied by the rotating coupon, however, the fluid will immediately begin to accelerate through (or toward) the microchannel 20 until it reaches the mixing chamber 16. As the path through which the fluid travels will generally affect the increase in velocity (or acceleration), the size and placement of the various reservoirs, channels, etc., in or on the test coupon can be designed to ensure that the first fluid reaches the target contact velocity as, or before, it enters the mixing chamber.

In addition, the test coupon 10 can include vent channels 30 and 32 which can be vented to atmospheric pressure (or to some other pressure sufficiently higher than “downstream” pressure) to allow the first fluid 14 to travel unrestricted through the microchannel 20 to ensure that the target contact velocity is reached. Similarly, vent channel 34 can be in communication with mixing chamber 16 to allow the first liquid to enter the mixing chamber to mix with the second liquid 18.

The mechanism used to rotate or spin test coupons of the present invention is not shown in the figures, it being understood that those having ordinary skill in the art can devise numerous rotational devices capable of rotating the present test coupons at rotational velocities suitable for the present methods. In addition, while it is anticipated that the present invention can be utilized in a variety of testing regimes, no particular testing regime is detailed herein, as those of ordinary skill in the art can readily incorporate the present invention into a variety of testing regimes.

The present invention thus provides an advantageous method of mixing the first 14 and second 18 liquids by injecting the first liquid into a mixing chamber 16 containing the second liquid. It is believed that, as the first liquid travels through the microchannel 20 and into the mixing chamber, laminar roll cells are developed that result in enhanced mixing of the two liquids. By retaining the first liquid in the fluid reservoir 12 until the target rotational rate is achieved, the first liquid is not allowed to travel through the microchannel until sufficient potential energy is stored in the first fluid to ensure that the first fluid reaches the target contact velocity as it enters, or prior to entering, the mixing chamber. In this manner, mixing of the two liquids can be achieved in a very rapid fashion, in contrast to conventional methods which may have to rely upon the very slow process of molecular diffusion to mix two liquids.

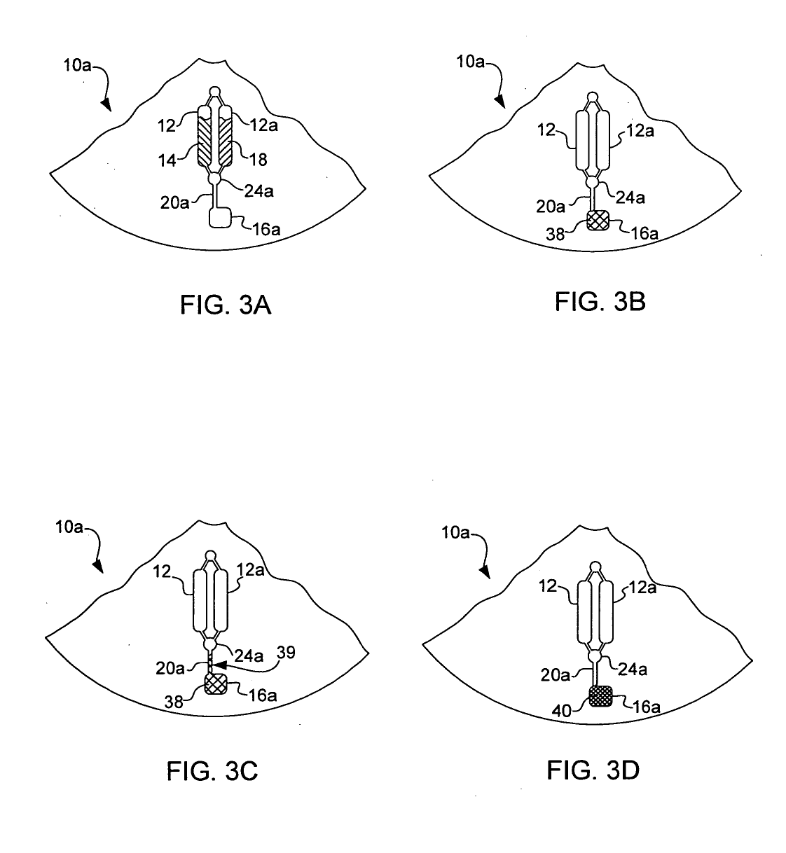

In the embodiment shown in FIG. 1, the second liquid 18 is stored in the mixing chamber 16 prior to mixing the first 14 and second liquids. Thus, in this aspect of the invention, only the first liquid travels through or on the coupon during the mixing process. As shown in FIGS. 2 and 3A through 3B, however, the present invention also provides a method for mixing at least two liquids utilizing test coupon 10a that includes a first fluid reservoir 12 containing first fluid 14, and a second fluid reservoir 12a containing second fluid 18. Vent valve 33 can be configured to provide adequate venting to the fluid reservoirs to allow fluid flow from the reservoirs. Also, while not shown in the figures, each of the fluid reservoirs and/or mixing chambers can be fluidly coupled to a vent valve or vent channel to allow substantially unrestricted fluid flow to, through and/or from the reservoirs or mixing chambers, as would occur to one having ordinary skill in the art.

Microchannel 20a can fluidly connect each of the first and second fluid reservoirs to mixing chamber 16a. Microchannels 21 and 23 can connect the first and second reservoirs, respectively, to microchannel 20a and thus to mixing chamber 16a. Thus, in this aspect of the invention, the mixing chamber of the coupon is initially empty, with the fluids to be mixed contained in separate fluid reservoirs located inwardly from the mixing chamber with respect to the axis of rotation of the coupon 10a.

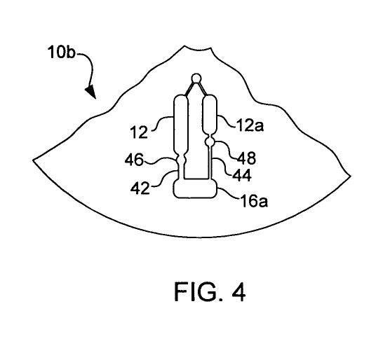

In the embodiment shown in FIGS. 2 and 3A through 3D, a single valve 24a is operably disposed between each reservoir 12,12a and the microchannel 20a and mixing chamber 16a. In this manner, the valve can be configured to release each fluid at the same time to allow the fluids to travel together at least through the microchannel 20a to the mixing chamber. Although some limited degree of mixing of the fluids can occur at the single valve, much of the mixing of the liquids occurs at the mixing chamber. In addition to this configuration, however, it is contemplated that each fluid can flow through a separate microchannel and can be controlled by a separate valve (shown, for example, in FIG. 4). In this manner, fluids with differing material properties can be delivered to the mixing chamber 16a at the same volumetric flow rate, or velocity. Alternately, each fluid could be released by its respective valve to enter the mixing chamber at different velocities.

Depending upon the material properties of the liquids being mixed, and the geometries of the various microchannels, reservoirs and mixing chambers through which the liquids travel, injection of the liquids into the mixing chamber can result in mixing of the first and second liquids to a level sufficient to satisfy the demands of a particular testing regime. However, it may be the case that, in some testing regimes, it is not feasible or desirable to generate sufficient rotational velocity to ensure that the target contact velocity of the fluid being injected into the mixing chamber is great enough to achieve sufficient mixing.

In these cases, the present invention provides a method of enhancing the mixing of the two liquids that includes the step of reducing rotational velocity of the coupon after at least the first liquid is injected into the mixing chamber to withdraw a quantity of the first and second liquids contained in the mixing chamber back into the microchannel. After this, the rotational velocity of the coupon can be increased to re-inject at least a portion of the quantity of the first and second liquids into the mixing chamber to increase a degree of mixing of the first and second liquids.

This process is shown incrementally in FIGS. 3A through 3D, where a section of coupon 10a is shown in each view. FIG. 3A shows the coupon 10a with first 14 and second 18 liquids held in fluid reservoirs 12 and 12a, respectively, prior to rotation of the coupon at or above the target rotational velocity. FIG. 3B illustrates the coupon after the coupon has been rotated at or above the target rotational velocity as both liquids 14 and 18 have been injected into and combined in mixing chamber 16a to form at least partially mixed liquid 38.

Turning now to FIG. 3C, the rotational velocity of the coupon 10a has been reduced resulting in at least a portion of a quantity 39 of the partially mixed liquid being withdrawn back into microchannel 20a. Next, as shown in FIG. 3D, rotational velocity of the coupon has again been increased and the quantity of the partially mixed liquid has be reinjected into the mixing chamber, resulting in mixed liquid 40 that is more thoroughly mixed than was mixed liquid 38.

The increased rotational velocity of the coupon used to reinject the partially mixed liquid into the mixing chamber can be a rotational velocity less than, equal to, or greater than the target rotational velocity. This is the case because, in most cases, the mixed liquid will not “creep” back along the microchannel past valve 24a, and can thus be reinjected back into the mixing chamber even at rotational speeds less than those necessary to originally release the liquids through the valve. It has been found, however, that increasing the rotational velocity of the coupon to a speed equal to or greater than the target rotational velocity produces more thorough mixing of the two liquids.

The step of withdrawing at least a portion of partially mixed liquid 38 back into microchannel 20a can be performed in a variety of manners. In one aspect of the invention, the rotational velocity of the coupon is reduced to a level sufficient to allow the mixed liquid to be withdrawn into the microchannel via capillary action. In this manner, the mixed liquid is “wicked” into the microchannel by merely reducing the rotational velocity of the coupon. In other embodiments, a pressure differential can be created between the microchannel and the mixing chamber 16a to force the partially mixed liquid into the microchannel. The pressure differential created can be caused by the fluids being forced into the mixing chamber via centripetal force, resulting in a lower pressure being created in the microchannel and/or fluid reservoir than exists in the mixing chamber.

The configuration of the coupon 10a in FIGS. 3A through 3D will generally result in the first liquid 14 and the second liquid 18 entering the mixing chamber 16a at approximately the same time and traveling at approximately the same volumetric flow rate, or velocity. However, in one embodiment of the invention, the coupon is configured such that the liquids enter the mixing chamber at different velocities and/or at different times. For example, in the embodiment of the invention shown at 10b in FIG. 4, the liquids (not shown in this view) can be contained in separate reservoirs 12, 12a and can be fluidly coupled to the mixing chamber 16a via separate microchannels 42, 44, respectively, with individual valves 46, 48, respectively, disposed between each reservoir and microchannel. As the valves can be openable at different rotational velocities, the release of each liquid can be done at a rotational velocity different from the other, resulting in the liquids being released from their respective reservoirs at different times and, in one embodiment, at different liquid flowrates after release.

In a similar fashion, in another aspect of the invention, the liquids are fluidly connected with the mixing chamber via microchannels that differ in at least one channel feature, as shown, for example, by microchannels 42 and 44 in FIG. 4. In this embodiment, the microchannels 42 and 44 differ in both a length, with microchannel 44 being of greater length than microchannel 42, and in width, with microchannel 42 having a greater width than microchannel 44. As used herein, the term “channel feature” is to be understood to refer to an aspect of the channel that generally alters or affects the rate of travel of a fluid through the microchannel. Channel features can include, but are not limited to, a path of the channel (e.g., straight or serpentine), a cross sectional area of the channel (e.g. larger or smaller in diameter), a length of the channel, and an inner finish of the channel. The inner finish of the channel can vary, for instance, in surface roughness, material treatment, etc., or in a variety of manners that affect the flow rate of a fluid through the channel.

While it is anticipated that the present invention can be utilized in a variety of testing and production regimes, no specific testing or production regime is detailed herein, as it is believed that those of ordinary skill in the art can readily incorporate the present invention into a variety of processes. In particular, it is contemplated that the present invention can be advantageously incorporated into testing regimes that utilize multiple fluid reservoirs, testing chambers, microchannels, reagents, etc., to perform multiple stages of tests, as would occur to one having ordinary skill in the art. It is contemplated that the present invention can be particularly effective in mixing two or more liquids to be tested as a mixture.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for mixing liquids on a microfluidic level, comprising the steps of:
placing a coupon in operable communication with a rotational device, said coupon including:
at least one fluid reservoir containing a first liquid;
a fluid mixing chamber; and
a microchannel interconnecting the fluid reservoir and the fluid mixing chamber;
determining a target contact velocity for the first liquid to enter the mixing chamber;
determining a target rotational velocity of the coupon at which the first liquid will be released from the fluid reservoir such that the first liquid is traveling at least at the target contact velocity as it enters the mixing chamber;
rotating the coupon at or above the target rotational velocity; and
releasing the first liquid from the fluid reservoir such that the first liquid travels through the microchannel and is injected into the mixing chamber at least at the target contact velocity, thereby mixing in the mixing chamber the first liquid with a second liquid present in the mixing chamber.

2. The method of claim 1, comprising the further steps of:
reducing rotational velocity of the coupon after the first liquid is injected into the mixing chamber, whereby a quantity of the first and second liquids contained in the mixing chamber are withdrawn back into the microchannel; and
increasing rotational velocity of the coupon to re-inject at least a portion of the quantity of the first and second liquids into the mixing chamber to increase a degree of mixing of the first and second liquids.

3. The method of claim 2, wherein the step of increasing rotational velocity of the coupon includes the step of increasing the rotational velocity to a velocity greater than the target rotational velocity.

4. The method of claim 2, wherein the step of reducing rotational velocity of the coupon includes the step of wicking the quantity of the first and second liquids back into the microchannel.

5. The method of claim 1, wherein the second liquid is contained in the fluid mixing chamber prior to mixing of the first and second liquids.

6. The method of claim 1, wherein the coupon includes a second fluid reservoir containing the second liquid, and comprising the further step of releasing the second liquid from the second fluid reservoir such that the second liquid enters the mixing chamber traveling at least at the target contact velocity to mix with the first liquid.

7. The method of claim 1, wherein the coupon includes a second fluid reservoir containing the second liquid and a second microchannel interconnecting the mixing chamber and the second fluid reservoir, the second microchannel having at least one channel feature differing from a channel feature of the first microchannel such that the second liquid enters the mixing chamber traveling at a velocity different than a velocity of the first liquid.

8. The method of claim 7, wherein the channel feature that is different is selected from the group consisting of a channel path, a channel cross sectional area, a channel length, an inner channel finish, and combinations thereof.

9. The method of claim 1, wherein the coupon includes at least one valve operably disposed between the fluid reservoir and the fluid mixing chamber, the at least one valve operable to selectively release the first liquid from the fluid reservoir to allow the first liquid to travel through the microchannel to the mixing chamber.

10. The method of claim 9, wherein the valve is selected from the group consisting of a manually operated valve, an automated valve, a passive valve, and combinations thereof.

11. The method of claim 10, wherein the valve is the passive valve, the passive valve being a capillary valve configured to allow flow of the first liquid from the fluid reservoir when the coupon rotates at or above the target rotational velocity.

12. A method for mixing liquids on a microfluidic level, comprising the steps of:
rotating a coupon to impart flow via centripetal force to a first liquid through a microchannel in the coupon to inject the first liquid into a mixing chamber and to mix the first liquid with a second liquid;
withdrawing a quantity of the first and second liquids from the mixing chamber; and
injecting at least a portion of the quantity of the first and second liquids into the mixing chamber to further mix the first and second liquids.

13. The method of claim 12, wherein the step of withdrawing a quantity of the first and second liquids includes the step of wicking the quantity of the first and second liquids back into the microchannel.

14. The method of claim 12, wherein the step of rotating the coupon includes the step of imparting flow via centripetal force to the second liquid to inject the second liquid into the mixing chamber to mix the first and second liquids.

15. The method of claim 14, wherein the first and second liquids are contained in separate fluid reservoirs associated with the coupon prior to rotating the coupon.

16. The method of claim 12, wherein the second liquid is contained in the mixing chamber prior to rotating the coupon.

17. The method of claim 12, wherein the coupon includes a second fluid reservoir containing the second liquid and a second microchannel interconnecting the mixing chamber and the second fluid reservoir, the second microchannel having at least one channel feature differing from a channel feature of the first microchannel such that the second liquid enters the mixing chamber traveling at a velocity different than a velocity of the first liquid.

18. The method of claim 17, wherein the channel feature is selected from the group consisting of a channel path, a channel cross sectional area, a channel length, and an inner channel finish, and combinations thereof.

19. The method of claim 12, wherein the coupon includes at least one valve operably disposed between the fluid reservoir and the fluid mixing chamber, the at least one valve operable to selectively release the first liquid from the fluid reservoir to allow the first liquid to travel through the microchannel to the mixing chamber.

20. The method of claim 19, wherein the valve is selected from the group consisting of a manually operated valve, an automated valve, a passive valve, and combinations thereof.

21. The method of claim 20, wherein the valve is the passive valve, the passive valve being a capillary valve configured to allow flow of the first liquid from the fluid reservoir when the coupon rotates at or above the target rotational velocity.

22. A method for mixing liquids on a microfluidic level, comprising the steps of:
placing a coupon in operable communication with a rotational device, said coupon including:
at least one fluid reservoir containing a first liquid;
a fluid mixing chamber; and
a microchannel interconnecting the fluid reservoir and the fluid mixing chamber;
determining a target contact velocity for the first liquid to enter the mixing chamber;
determining a target rotational velocity of the coupon at which the first liquid will be released from the fluid reservoir such that the first liquid is traveling at least at the target contact velocity as it enters the mixing chamber;
rotating the coupon at the target rotational velocity;
releasing the first liquid from the fluid reservoir such that the first liquid travels through the microchannel and is injected into the mixing chamber at least at the target contact velocity, thereby mixing in the mixing chamber the first liquid with a second liquid;
reducing rotational velocity of the coupon after the first liquid is injected into the mixing chamber, whereby a quantity of the first and second liquids contained in the mixing chamber are withdrawn back into the microchannel; and
increasing rotational velocity of the coupon to re-inject at least a portion of the quantity of the first and second liquids into the mixing chamber to increase a degree of mixing of the first and second liquids.

23. The method of claim 22, wherein the step of increasing rotational velocity of the coupon includes the step of increasing the rotational velocity to a velocity greater than the target rotational velocity.

24. The method of claim 22, wherein the step of reducing rotational velocity of the coupon includes the step of wicking the quantity of the first and second liquids back into the microchannel.

25. The method of claim 22, wherein the second liquid is contained in the fluid mixing chamber prior to mixing of the first and second liquids.

26. The method of claim 22, wherein the coupon includes a second fluid reservoir containing the second liquid, and comprising the further step of releasing the second liquid from the second fluid reservoir such that the second liquid enters the mixing chamber traveling at least at the target contact velocity to mix with the first liquid.

27. The method of claim 22, wherein the valve is a passive, capillary valve configured to allow flow of the first liquid from the fluid reservoir when the coupon rotates at or above the target rotational velocity.
